(19) United States
(12) Patent Application Publication
(10) Pub. No.: US 2022/0316951 A1
(43) Pub. Date: Oct. 6, 2022

(54) INFRARED TEMPERATURE SENSOR

(71) Applicant: ORIENTAL SYSTEM TECHNOLOGY INC., Hsinchu (TW)

(72) Inventors: Ming LE, New Taipei City (TW); Jenping KU, Hsinchu County (TW); Chein-Hsun WANG, Hsin-Chu (TW); Yu-Chih LIANG, Hsinchu City (TW)

(21) Appl. No.: 17/338,308

(22) Filed: Jun. 3, 2021

(30) Foreign Application Priority Data
Mar. 31, 2021 (TW) 110111999

(51) Int. Cl. G01J 5/12; G01J 5/08; G01K 7/22; G01K 7/01

(52) U.S. Cl. CPC G01J 5/12; G01J 5/0875; G01J 5/0809; G01K 7/22; G01K 7/015; H04L 12/40

(57) ABSTRACT

An infrared temperature sensor comprises a thermopile sensor and an infrared reflector, wherein the infrared reflector reflects the infrared ray radiated by a target to a first thermopile sensing element of the thermopile sensor to sense the temperature of the target. By appropriately designing the reflecting surface of the infrared reflector, a horizontal viewing angle of a sensing range of the infrared temperature sensor can be larger, while a vertical viewing angle is smaller. The thermopile sensor further comprises a second thermopile sensing element, which can sense the thermal radiation of a package structure, whereby to compensate for the measurement error induced by the temperature variation of the package structure, which results from the variation of the environmental temperature. Thus, the measurement accuracy is increased.

### BACKGROUND OF THE INVENTION

### 1. Field of the Invention

The present invention relates to a temperature sensor, particularly to a non-contact infrared temperature sensor.

### 2. Description of the Prior Art

For industry safety, the temperatures of apparatuses need to be monitored in many situations, whereby to send out alarms or interrupt power supply while an abnormality occurs. For example, the connector of the power supply of a server or a gaming computer are likely to be deteriorated by the high temperature resulting from large current due to bad soldering in contact; thus, the connector may burn out or even catch fire because of too high a temperature. In the abovementioned situations, the space where temperature needs monitoring has a larger horizontal viewing angle and a smaller vertical viewing angle. In another case, the cold compartments of a refrigerator are normally wider in the horizontal direction and narrower in the vertical direction. Therefore, the space where temperature needs monitoring has a larger horizontal viewing angle and a smaller vertical viewing angle in the case of cold compartments.

Refer to FIG. 1. The case that a conventional infrared temperature sensor measures the temperature of the connector of the power supply of a motherboard is used as a demonstration. A target T (such as a power supply connector) is disposed on a motherboard 10. An infrared temperature sensor 122 is disposed on a substrate 121. The substrate 121 is inserted into a connector 11, which is closed to the target T, whereby the substrate 121 is electrically connected with the motherboard 10. Then, the infrared temperature sensor 122 can measure the temperature of the target T. As the power supply connector (the target T) has a smaller height (about 13 mm), the infrared temperature sensor 122 does not need too large a vertical viewing angle (such 10-20 degrees). As the power supply connector (the target T) has a larger width (about 35 mm), the infrared temperature sensor 122 needs a larger horizontal viewing angle (about 40-90 degrees). In order to meet the abovementioned scenario, a metallic shield plate is disposed above an infrared window of a thermopile sensor of a conventional infrared temperature sensor to limit the viewing angle in the vertical direction. However, such a measure would greatly reduce the sensitivity of the thermopile sensor.

In order to match the height (about 13 mm) of the power supply connector (the target T), the infrared temperature sensor 122 should be disposed at an altitude of 5-6 mm. However, it is somewhat difficult to dispose the infrared temperature sensor 122 at an altitude of 5-6 mm because of the limitation applied by the connector 11 (such as a Micro USB connector). Refer to FIG. 2. The current approach to adjust the altitude of the infrared temperature sensor 122 is to dispose the infrared temperature sensor 122 on an L-shaped substrate 221, whereby to escape from the spatial limitation of the connector 11. Although the approach shown in FIG. 2 can adjust the altitude of the infrared temperature sensor 122 easily, it occupies a larger area of the motherboard 10.

It should be noted: the measurement accuracy of a non-contact infrared temperature sensor is likely to be influenced by instability of the environmental temperature. For example, intermittent operation of the cooling fan of a computer or the circulation fan of a refrigerator would greatly vary the environmental temperature and result in measurement errors of an infrared temperature sensor.

Hence there is a need to develop an infrared temperature sensor that has different viewing angle in horizontal and vertical direction and can measure object temperature accurately regardless the ambient temperature variation.

### SUMMARY OF THE INVENTION

The present invention provides an infrared temperature sensor, which uses an infrared reflector to redirect the infrared ray radiated by a target to a first thermopile sensing element to sense the temperature of the target. Via appropriately designing a reflecting surface of the infrared reflector, the sensation range of the infrared temperature sensor may have a larger horizontal viewing angle and a smaller vertical viewing angle. The infrared temperature sensor of the present invention further comprises a second thermopile sensing element to detect the thermal radiation of the package structure, whereby to compensate for the measurement errors caused by variation of environmental temperature and promote the measurement accuracy.

In one embodiment, the infrared temperature sensor of the present invention comprises a thermopile sensor and an infrared reflector. The thermopile sensor includes a substrate, a cover, at least one first thermopile sensing element, a second thermopile sensing element, a filter, an ambient temperature sensor, and a signal processor. The cover is disposed on the substrate and cooperates with the substrate to define an accommodation space. The cover further includes a window and a shield member. The at least one first thermopile sensing element is disposed on the substrate and inside the accommodation space and electrically connected with the substrate. The first thermopile sensing element is corresponding to the window of the cover to receive a first infrared ray radiated by a target in the exterior and generate a first sensation signal. The second thermopile sensing element is disposed on the substrate and inside the accommodation space and electrically connected with the substrate. The second thermopile sensing element is corresponding to the shield member of the cover to receive a second infrared ray radiated by the shield member and generate a second sensation signal. The filter is disposed on the window to screen a specified range of wavelengths of the first infrared ray. The ambient temperature sensor detects am ambient temperature to generate an ambient temperature sensation signal. The signal processor is electrically connected with the first thermopile sensing element, the second thermopile sensing element and the ambient temperature sensor to process the first sensation signal, the second sensation signal and the ambient temperature sensation signal. The infrared reflector is disposed at the front end of the window, reflecting the first infrared ray to the at least one first thermopile sensing element and defining a sensation range of the at least one first thermopile sensing element. The sensation range has a viewing angle greater than or equal to 55 degrees in a first direction and a viewing angle smaller than or equal to 35 degrees in a second direction. The second direction is vertical to the first direction.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein

FIG. 1 is a diagram schematically showing that a conventional infrared temperature sensor measures the temperature of a power supply connector of a motherboard;

FIG. 2 is a diagram schematically showing that another conventional infrared temperature sensor is disposed on a motherboard;

FIG. 3 is a sectional view schematically showing an infrared temperature sensor according to one embodiment of the present invention;

FIG. 4 is a top view schematically showing an infrared temperature sensor according to one embodiment of the present invention;

FIG. 5 is a top view schematically showing a thermopile sensor with the cover and the filter removed according to one embodiment of the present invention;

FIG. 6 is a sectional view schematically showing a thermopile sensor according to one embodiment of the present invention, wherein the sectional view is taken along Line AA in FIG. 5;

FIG. 7 is a diagram schematically showing a signal processor of an infrared temperature sensor according to one embodiment of the present invention.

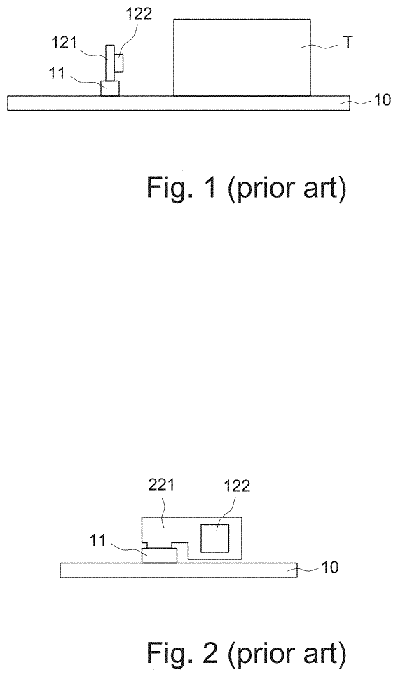

### DESCRIPTION OF THE PREFERRED EMBODIMENTS

Various embodiments of the present invention will be described in detail below and illustrated in conjunction with the accompanying drawings. In addition to these detailed descriptions, the present invention can be widely implemented in other embodiments, and apparent alternations, modifications and equivalent changes of any mentioned embodiments are all included within the scope of the present invention and based on the scope of the Claims. In the descriptions of the specification, in order to make readers have a more complete understanding about the present invention, many specific details are provided; however, the present invention may be implemented without parts of or all the specific details. In addition, the well-known steps or elements are not described in detail, in order to avoid unnecessary limitations to the present invention. Same or similar elements in Figures will be indicated by same or similar reference numbers. It is noted that the Figures are schematic and may not represent the actual size or number of the elements. For clearness of the Figures, some details may not be fully depicted.

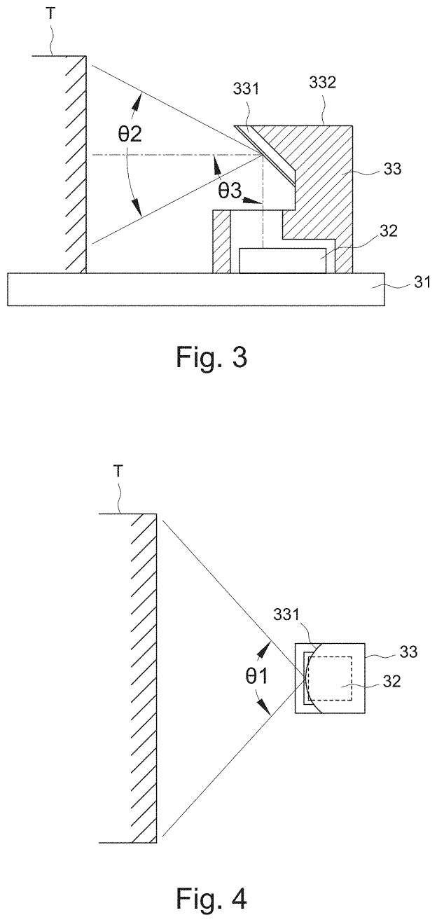

Refer to FIG. 3 and FIG. 4. In one embodiment, the infrared temperature sensor of the present invention comprises a thermopile sensor 32 and an infrared reflector 33. In the embodiment shown in FIG. 3, the thermopile sensor 32 is disposed on a circuit board 31, such as a motherboard, to sense the temperature of a target T (such as a power supply connector). The detailed structure of the thermopile sensor 32 will be described below.

The infrared reflector 33 is configured to reflect the infrared ray radiated by the target T to the thermopile sensor 32. For example, a reflecting surface 331 of the infrared reflector 33 is disposed at the front end of the thermopile sensor 32, whereby to reflect the infrared ray radiated by the target T to the thermopile sensor 32. It should be noted: a sensation range of the infrared reflector 33 can be defined via an appropriate design of the structure of the reflecting surface 331. For example, the reflecting surface 331 of the infrared reflector 33 may be a convex surface to make the sensation range of the thermopile sensor 32 have a larger viewing angle θ1 in a first direction (such as the horizontal direction) and a smaller viewing angle θ2 in a second direction (such as the vertical direction); the second direction is vertical to the first direction. For example, the sensation range has a viewing angle θ1 of larger than or equal to 55 degrees in a first direction. In one embodiment, the sensation range has a viewing angle θ1 of larger than or equal to 90 degrees in a first direction; the sensation range has a viewing angle θ2 of smaller than or equal to 35 degrees in a second direction. In one embodiment, the first direction is parallel to a surface of a substrate 321 of the thermopile sensor 32 (as shown in FIG. 6). It is easily understood: the structure of the reflecting surface 331 may be appropriately modified according to the application scenario or the shape of the target T to make the first direction not parallel to the substrate 321 of the thermopile sensor 32.

Refer to FIG. 3 again. It is easily understood: an optical axis from the target T to the thermopile sensor 32 forms an included angle θ3 via the reflection of the infrared reflector. The infrared temperature sensor of the present invention can detect the temperature of the target T at different altitude via adjusting the included angle θ3.

In one embodiment, the reflecting surface 331 of the infrared reflector 33 includes a metal layer. For example, the reflecting surface 331 may be electroplated with a metal layer made of a metal selected from a group including aluminum, nickel, chromium, gold and alloys thereof, whereby to increase the reflectivity of infrared light.

It is easily understood: the convex reflecting surface 331 will induce the variation of the intensity of the infrared ray on the reception side of the thermopile sensor 32. For example, the intensity of the infrared ray is higher in the central region and lower in the region far away from the central region. Such a situation will result in errors of temperature measurement. In one embodiment, the central region of the reflecting surface 331 is processed with a roughening treatment to make the surface roughness of the central region of the reflecting surface 331 higher than the surface roughness of the peripheral region of the reflecting surface 331. Thereby, the reflecting effect of the central region of the reflecting surface 331 is decreased, and the intensity distribution is homogenized on the reception side of the thermopile sensor 32. In one embodiment, the surface roughness of the central region of the reflecting surface 331 is smaller than or equal to 3 μm; the surface roughness of the peripheral region of the reflecting surface 331 is smaller than or equal to 0.1 μm.

Refer to FIG. 3 again. The infrared reflector 33 includes a top surface 332, which is a plane parallel to the substrate 321 of the thermopile sensor 32 (as shown in FIG. 6). The fabrication apparatus may suck the top surface 332 to perform a positioning procedure, a gluing procedure, etc., whereby to favor automatic production.

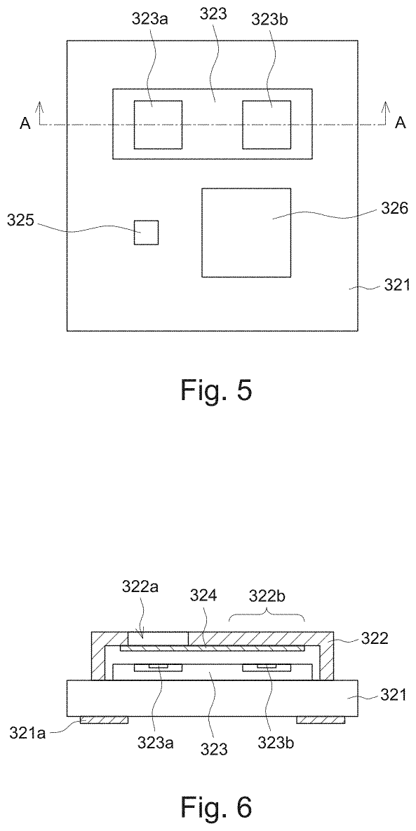

Refer to FIG. 5 and FIG. 6 for the structure of the thermopile sensor 32. The thermopile sensor 32 includes a substrate 321, a cover 322, at least one first thermopile sensing element 323a, a second thermopile sensing element 323b, a filter 324, an ambient temperature sensor 325, and a signal processor 326. In one embodiment, the substrate 321 is made of a bismaleimide triazine resin or a ceramic material. It is easily understood: the substrate 321 includes a plurality of electric-conduction contacts and a plurality of electric-conduction traces used to electrically connect corresponding electric-conduction contacts. Thereby, the electronic elements on the substrate 321 can be electrically connected with the substrate 321, and the generated sensation signals can be output to the exterior through electric-conduction contacts 321a. The detailed structure of the substrate 321 is well known by the persons skilled in the art and will not repeat herein.

The first thermopile sensing element 323a and the second thermopile sensing element 323b are disposed on the substrate 321 and electrically connected with the substrate 321. The first thermopile sensing element 323a is used to receive a first infrared ray and generate a first sensation signal. The second thermopile sensing element 323b is used to receive a second infrared ray and generate a second sensation signal. In the embodiment shown in FIG. 5 and FIG. 6, the first thermopile sensing element 323a and the second thermopile sensing element 323b are integrated in a single chip 323. In one embodiment, the chip 323 is fixedly mounted on the substrate 321 using a heat-conduction glue. The heat-conduction glue can decrease the thermal resistance between the substrate 321 and the chip 323 and favors detection of the ambient temperature.

The ambient temperature sensor 325 is used to detect the ambient temperature and generate an ambient temperature sensation signal. In one embodiment, the ambient temperature sensor 325, the first thermopile sensing element 323a and the second thermopile sensing element 323b are integrated in the single chip 323. In one embodiment, the ambient temperature sensor 325 is a silicon-based temperature sensor. In one embodiment, the silicon-based temperature sensor includes a plurality of cascade Schottky diodes. In one embodiment, the ambient temperature sensor 325 is an independent element. For example, the ambient temperature sensor 325 is a thermistor, which is disposed on the substrate 321 and electrically connected with the substrate 321 and outputs corresponding ambient temperature sensation signals.

The signal processor 326 is electrically connected with the first thermopile sensing element 323a, the second thermopile sensing element 323b and the ambient temperature sensor 325. The signal processor 326 processes the first sensation signal, the second sensation signal and the ambient temperature sensation signal, which are respectively output by the first thermopile sensing element 323a, the second thermopile sensing element 323b and the ambient temperature sensor 325, to work out the temperature of the target T. In one embodiment, the first thermopile sensing element 323a is reversely cascaded to the second thermopile sensing element 323b, whereby to output a difference of the first sensation signal and the second sensation signal and simplify the processing of the signal processor 326. In one embodiment, the signal processor 326, the first thermopile sensing element 323a, the second thermopile sensing element 323b and the ambient temperature sensor 325 are integrated in the single chip 323.

The cover 322 is disposed on the substrate 321 and cooperates with the substrate 321 to define an accommodation space. The first thermopile sensing element 323a, the second thermopile sensing element 323b, the ambient temperature sensor 325 and the signal processor 326, are disposed inside the accommodation space between the cover 322 and the substrate 321. In one embodiment, the cover 322 is fixedly mounted on the substrate 321 using a heat-conduction glue. The heat-conduction glue can decrease the thermal resistance between the cover 322 and the substrate 321, whereby the temperature of the substrate 321 can easily vary with the ambient temperature.

The cover 322 includes a window 322a and a shield member 322b. The window 322a is disposed corresponding to the first thermopile sensing element 323a, whereby the first thermopile sensing element 323a can receive thermal radiation, such as the first infrared ray radiated by the target T, from the exterior through the window 322a. The shield member 322b is disposed corresponding to the second thermopile sensing element 323b, whereby the second thermopile sensing element 323b can only receive the second infrared ray radiated by the shield member 322b. In the embodiment shown in FIG. 6, the shield member 322b is formed by a portion of the cover 322. However, the present invention is not limited by this embodiment. In one embodiment, the cover 322 includes another window, which is corresponding to the second thermopile sensing element 323b; a shield element may be disposed on one side of the window corresponding to the second thermopile sensing element 323b to shield the thermal radiation from external heat sources, whereby the same effect is achieved. In one embodiment, the shield element includes a substrate and a shield layer formed on the surface of the substrate. For example, the shield layer may be a metal layer that can shield external thermal radiation.

The filter 324 is disposed on one side of the window 322a, allowing the infrared ray having a specified range of wavelengths to pass. In one embodiment, the filter 324 is fixedly mounted on the cover 322 using a heat-conduction glue. The heat-conduction glue can decrease the thermal resistance between the cover 322 and the filter 324, whereby the temperature of the filter 324 can easily vary with the temperature of the cover 322. In one embodiment, the filter 324 includes a substrate and a filter layer disposed on the substrate, wherein the substrate is a silicon substrate. In one embodiment, the filter 324 is disposed on an inner side of the cover 322 and extended to a position between the second thermopile sensing element 323b and the shield member 322b, whereby the second sensation signal output by the second thermopile sensing element 323b can be used to compensate for the thermal radiation generated by the filter 324.

According to the structure described above, the first thermopile sensing element 323a can sense the thermal radiation from the exterior through the window 322a of the cover 322; the second thermopile sensing element 323b senses the thermal radiation of the shield member 322b of the cover 322 (i.e. the package body), which is to be used in calibration and compensation. While the ambient temperature is instable (for example, the ambient temperature varies because of the selective start of the cooling fan of a server or the circulation fan of a refrigerator), the infrared temperature sensor of the present invention can fast calibrate and compensate for the measurement error resulting from the temperature change of the package body, which is caused by the ambient temperature change. Therefore, the present invention can increase the accuracy of temperature measurement.

In one embodiment, the thermopile sensor includes a plurality of first thermopile sensing elements 323a, and the cover 322 includes a plurality of corresponding filters, whereby is formed a multi-channel infrared temperature sensor. In one embodiment, the filters, which are respectively corresponding to different first thermopile sensing elements 323a, screen different ranges of wavelengths; thus, different first thermopile sensing elements 323a can respectively detect the intensities of different infrared rays having different ranges of wavelengths to learn the intensity distribution of different wavelengths of the infrared rays radiated by the target. Thereby, the temperature of the target is accurately measured.

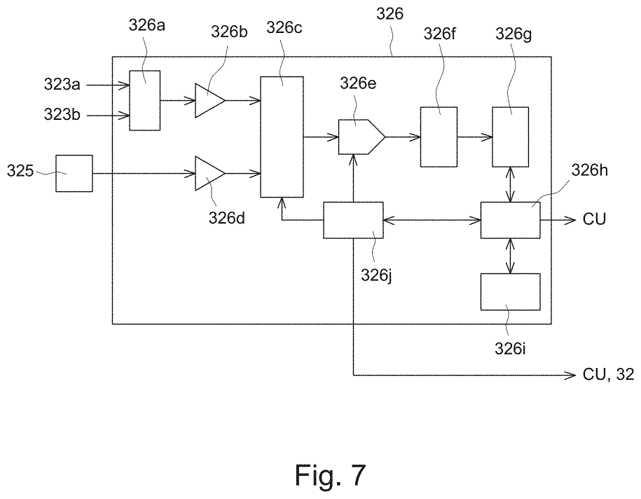

Refer to FIG. 7. In one embodiment, the signal processor 326 includes multiplexers 326a and 326c, a programmable amplifier 326b, a buffer amplifier 326d, an analog-to-digital converter 326e, a digital filter 326f, a register 326g, a communication interface 326h, a non-volatile memory 326i and a procedure controller 326i. The sensation signals of the first thermopile sensing element 323a and the second thermopile sensing element 323b are output to the multiplexer 326a for selection. The programmable amplifier 326b amplifies the signal selected by the multiplexer 326a and feeds back the amplified signal to the multiplexer 326c. The ambient temperature sensation signal of the ambient temperature sensor 325 is output to the buffer amplifier 326d. The buffer amplifier 326d amplifies the ambient temperature sensation signal and feeds back the amplified signal to the multiplexer 326c. The multiplexer 326c performs selection to determine which one of the sensation signals of the first thermopile sensing element 323a, the second thermopile sensing element 323b and the ambient temperature sensor 325 is to be output to the analog-to-digital converter 326e. The analog-to-digital converter 326e converts the sensation signal into a digital signal. The digital filter 326f processes the digital signal and stores the result to the register 326g. In one embodiment, the analog-to-digital converter 326e is a Sigma-Delta analog-to-digital converter, such as a 16-24 bit high precision Sigma-Delta analog-to-digital converter.

The communication interface 326h communicates with an external controller CU through a first communication port, whereby to read data from or store data into the register 326g or the non-volatile memory 326i (such as the calibration parameters of the infrared temperature sensor and unique address data), select a signal channel and trigger the operation of the procedure controller 326i. In one embodiment, the first communication port is a bus structure; the external controller CU and the infrared temperature sensor of the present invention selectively undertakes broadcasting or unicasting through the first communication port. Through a second communication port and the external controller CU/another infrared temperature sensor, the procedure controller 326i makes a plurality of infrared temperature sensors cascaded to the external controller for communication and address administration. For example, the external controller CU assigns a piece of corresponding address data to each infrared temperature sensor. Please refer to a Taiwan patent of publication No.M607216 for a detailed description of address administration. In one embodiment, the non-volatile memory 326i is an electrically-erasable programmable read-only memory (EEPROM), a flash memory, or a multiple-times programmable (MTP) memory. The circuit design of the signal processor 326 is well known by the persons skilled in the art and will not repeat herein.

In conclusion, the infrared temperature sensor of the present invention uses an infrared reflector to reflect the infrared ray radiated by a target to a first thermopile sensing element, whereby to sense the temperature of the target. The present invention makes the sensation range of the infrared temperature sensor have a larger horizontal viewing angle and a smaller vertical viewing angle via appropriately designing the reflecting surface of the infrared reflector. The infrared temperature sensor of the present invention further comprises a second thermopile sensing element, which can sense the thermal radiation of the package structure, whereby to calibrate and compensate for the measurement error resulting from the temperature change of the package structure, which is caused by the ambient temperature change. Therefore, the present invention can increase the accuracy of temperature measurement.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the appended claims.

What is claimed is:

1. An infrared temperature sensor, comprising:
a thermopile sensor, including:
a substrate;
a cover, disposed on the substrate and cooperating with the substrate to define an accommodation space, wherein the cover includes a window and a shield member;
at least one first thermopile sensing element, disposed on the substrate and inside the accommodation space, and electrically connected with the substrate, wherein the first thermopile sensing element is corresponding to the window of the cover to receive a first infrared ray radiated by an external target to generate a first sensation signal;
a second thermopile sensing element, disposed on the substrate and inside the accommodation space, and electrically connected with the substrate, wherein the second thermopile sensing element is corresponding to the shield member of the cover to receive a second infrared ray radiated by the shield member to generate a second sensation signal;
a filter, disposed on the window, screening the first infrared ray having a specified range of wavelengths;
an ambient temperature sensor, sensing an ambient temperature to generate an ambient temperature sensation signal; and
a signal processor, electrically connected with the first thermopile sensing element, the second thermopile sensing element and the ambient temperature sensor to process the first sensation signal, the second sensation signal and the ambient temperature sensation signal; and
an infrared reflector, disposed at a front end of the window of the cover to deflect the first infrared ray to the at least one first thermopile sensing element and define a sensation range of the at least one first thermopile sensing element, wherein the sensation range has a viewing angle larger than or equal to 55 degrees in a first direction and has a viewing angle smaller than or equal to 35 degrees in a second direction; and the second direction is vertical to the first direction.

2. The infrared temperature sensor according to claim 1, wherein the first direction is parallel to a surface of the substrate.

3. The infrared temperature sensor according to claim 1, wherein a reflecting surface of the infrared reflector is a convex surface; and an optical axis from the target through the infrared reflector to the first thermopile sensing element has an included angle.

4. The infrared temperature sensor according to claim 1, wherein a reflecting surface of the infrared reflector includes a central region and a peripheral region on a perimeter of the central region; and a surface roughness of the central region is larger than a surface roughness of the peripheral region.

5. The infrared temperature sensor according to claim 4, wherein the surface roughness of the central region is smaller than or equal to 3 μm; the surface roughness of the peripheral region is smaller than or equal to 0.1 μm.

6. The infrared temperature sensor according to claim 1, wherein a reflecting surface of the infrared reflector includes a metal layer.

7. The infrared temperature sensor according to claim 6, wherein the metal layer includes aluminum, nickel, chromium, gold, or an alloy thereof.

8. The infrared temperature sensor according to claim 1, wherein the infrared reflector includes a top surface; and the top surface is a plane parallel to substrate.

9. The infrared temperature sensor according to claim 1, wherein the first thermopile sensing element and the second thermopile sensing element are integrated in a single chip.

10. The infrared temperature sensor according to claim 1, wherein the first thermopile sensing element is reversely cascaded to the second thermopile sensing element to output a difference of the first sensation signal and the second sensation signal.

11. The infrared temperature sensor according to claim 1, wherein the filter is disposed on an inner side of the cover and extended to a position between the second thermopile sensing element and the shield member.

12. The infrared temperature sensor according to claim 1, wherein the thermopile sensor includes a plurality of the first thermopile sensing elements and a plurality of the filters; and the filters respectively screen different ranges of wavelengths.

13. The infrared temperature sensor according to claim 1, wherein the ambient temperature sensor is a thermistor disposed inside the accommodation space or a silicon-based temperature sensor integrated with the first thermopile sensing element and the second thermopile sensing element in a single chip.

14. The infrared temperature sensor according to claim 13, wherein the silicon-based temperature sensor includes a plurality of cascade Schottky diodes.

15. The infrared temperature sensor according to claim 1, wherein the first thermopile sensing element, the second thermopile sensing element, the ambient temperature sensor and the signal processor are integrated in a single chip.

16. The infrared temperature sensor according to claim 1, wherein the signal processor includes:
a first communication port, being a bus structure, wherein an external controller and the infrared temperature sensor undertake broadcasting communication or unicasting communication through the first communication port; and
a second communication port, cascading a plurality of the infrared temperature sensors to the external controller to enable each of the infrared temperature sensors to receive a piece of address data that the external controller assigns to the infrared temperature sensor.

17. The infrared temperature sensor according to claim 16, wherein the signal processor includes a non-volatile memory for storing the address data and a calibration parameter of the infrared temperature sensor.
